(19) United States
(12) Patent Application Publication
(10) Pub. No.: US 2021/0267359 A1
(43) Pub. Date: Sep. 2, 2021

(54) TOOTHBRUSH HEAD, TOOTHBRUSH, METHOD FOR PRODUCING A TOOTHBRUSH HEAD, METHOD FOR PRODUCING A TOOTHBRUSH, ADDITIVE MANUFACTURING DEVICE, COMPUTER PROGRAM AND COMPUTER-READABLE MEDIUM

(71) Applicant: Zahoransky AG, Todtnau (DE)

(72) Inventors: Florian KIEFER, Frohnd (DE); Ingo KUMPF, Todtnau (DE); Marc KONIG, Freiburg (DE)

(73) Assignee: Zahoransky AG, Todtnau (DE)

(21) Appl. No.: 17/174,735

(22) Filed: Feb. 12, 2021

(30) Foreign Application Priority Data
Feb. 28, 2020 (DE) 102020105351.7

(51) Int. Cl. A46B 5/00; A46B 3/00; A46B 7/04; A46B 15/00; B33Y 80/00; B33Y 50/02

(52) U.S. Cl. CPC A46B 5/0095; A46B 3/005; A46B 7/044; A46B 2200/1066; B33Y 80/00; B33Y 50/02; A46B 15/0038

(57) ABSTRACT

A toothbrush head (3) is provided, the cleaning element carrier (11) of which and/or at least one cleaning element (12, 12a, 12b, 12c) of the toothbrush head (3) are/is produced via an additive manufacturing process.

### INCORPORATION BY REFERENCE

The following documents are incorporated herein by reference as if fully set forth: German Patent Application No. 10 2020 105 351.7, filed Feb. 28, 2020.

### TECHNICAL FIELD

The invention relates to a toothbrush head, to a toothbrush, to a method for producing a toothbrush head, to a method for producing a toothbrush, to an additive manufacturing device, to a computer program and to a computer-readable medium.

### BACKGROUND

Very generally, there is nowadays an increasing need to individualize even products of everyday use in accordance with user requirements. Even in the case of toothbrushes, consequently an increase in different designs and forms of design can therefore be observed. The design adaptations also detect the parts and regions responsible for the cleaning action of the toothbrushes, for example the toothbrush head and the cleaning elements thereof. The methods used previously for manufacturing toothbrushes may reach their limits of providing the desired multiplicity of variants in an economically viable way.

### SUMMARY

It is therefore the object of the invention to provide a toothbrush head, a toothbrush, a method for producing a toothbrush head, a method for producing a toothbrush, an additive manufacturing device, a computer program and a computer-readable medium of the type mentioned at the beginning, which permit the comparatively simple consideration of individual design requirements.

In order to achieve the object, first of all a toothbrush head is proposed which comprises one or more features described herein that is directed toward a toothbrush head of this type. In order to achieve the object, in particular a toothbrush head having a cleaning element carrier and having at least one cleaning element arranged on the cleaning element carrier is therefore proposed, wherein the cleaning element carrier and/or the at least one cleaning element are/is produced additively, in particular 3D printed.

The cleaning element carrier and the at least one toothbrush head cleaning element arranged thereon are the components of the toothbrush that are crucial for the cleaning action thereof. The production of the cleaning element carrier and/or of the at least one cleaning element of the toothbrush head by means of an additive manufacturing method, in particular by means of 3D printing, permits individualization of the toothbrush head virtually as desired in a comparatively simple manner. The at least one additively produced toothbrush head cleaning element can assume virtually any desired shape and can thus be adapted to individual requirements of a user, for example to anatomical requirements and/or dental anatomy requirements. It is thereby possible to provide a toothbrush head having at least one cleaning element which can be customized to a dental anatomy of a user.

By means of the additive production of the cleaning element carrier of the toothbrush head, it is also possible to provide said toothbrush head not only comparatively simply in different sizes, but also in different forms of design.

By means of the additive production of the cleaning element carrier and/or of the at least one cleaning element of the toothbrush head, it is furthermore possible to produce the toothbrush head according to the invention without a complicated brush production machine. When required, the production of the toothbrush head according to the invention can even be carried out at home by the user or end user themselves on their own additive manufacturing device, for example on a 3D printer.

In one embodiment of the toothbrush head, it is provided that at least one cleaning element of the toothbrush head is an additively produced, in particular 3D printed bristle filament. The use of an additively produced, in particular 3D printed bristle filament on the toothbrush head avoids the comparatively complex handling of bristle filaments and also the comparatively complex method steps for fastening the at least one bristle filament to the cleaning element carrier. By means of an additive manufacturing method, the at least one cleaning element in the form of a bristle filament can be attached to virtually any desired point of the cleaning element carrier of the toothbrush head. This permits the toothbrush head manufacturer to have a previously unexpected freedom of design.

In one embodiment of the toothbrush head, it is provided that at least one cleaning element is attached laterally to the cleaning element carrier, in particular molded on additively, in particular 3D printed thereon. Especially if the at least one cleaning element is intended to be attached laterally to the cleaning element carrier, it can be advantageous to mold the at least one cleaning element additively onto the cleaning element carrier. In this context, laterally can mean that the at least one cleaning element is attached to a side surface of the cleaning element carrier, said side surface being oriented transversely or at a right angle to a front side of the cleaning element carrier, on which front side at least one further cleaning element of the toothbrush head, for example at least one further bristle filament or else a set of bristle filaments or a set of bristle bundles composed of bristle filaments can be arranged.

In one embodiment of the toothbrush head, it is provided that at least one, in particular additively produced, preferably 3D printed, cleaning element connects two mutually averted side surfaces of the cleaning element carrier to each other and/or spans a front side of the cleaning element carrier. The cleaning element spanning the front side of the cleaning carrier can be fastened by a first of its two ends to a first side surface of the cleaning element carrier and by a second of its two ends to a second side surface of the cleaning element carrier. If the cleaning element which then connects the two side surfaces of the cleaning element carrier to each other is an additively produced cleaning element, this can significantly simplify the fastening of the cleaning element to the cleaning element carrier of the toothbrush head. A separate device for providing and handling the cleaning element to be fastened is unnecessary here. The cleaning element can be additively produced in virtually any desired configuration, i.e., for example, printed by means of layered application, and, in the process, can be fixed to the cleaning element carrier and to the side surfaces thereof.

In one embodiment of the toothbrush head, the latter has at least one, in particular additively produced, preferably 3D printed, cleaning element which has at least one cleaning segment, in particular at least two cleaning segments, preferably a plurality of cleaning segments, at its free end. A cleaning element of this type can have at least one or else a plurality of cleaning segments at its free end, which can have a positive effect on the cleaning action of the cleaning element. For example, it is possible to provide a cleaning element, at the free end of which at least one or two cleaning segments are arranged, said cleaning segments each having smaller cross sections in comparison to a cross section of the cleaning element in a portion adjacent to the cleaning segments. The finer cleaning segments of the cleaning element mean that the latter can thereby be particularly readily suitable, for example, for interdental cleaning.

In one embodiment of the toothbrush head, the previously mentioned cleaning segments can be configured, for example, in a nail-shaped, hook-shaped or else spherical manner.

In one embodiment of the toothbrush head, it is provided that at least one, in particular additively produced, preferably 3D printed, cleaning element has a cavity for receiving an effective substance, for example a cleaning agent, and an outlet opening from the cavity for dispensing the substance. It is thereby possible to provide a cleaning element on the toothbrush head, in the cavity of which cleaning element, for example, a tooth cleaning agent can be introduced as the substance. The substance in the cavity can be dispensed via the outlet opening into a user's oral cavity during use of the toothbrush head.

In a further embodiment of the toothbrush head, it is provided that the cleaning element carrier has at least one receiving hole for a cleaning element, wherein the receiving hole is produced by additive material application, in particular by 3D printing. A toothbrush head can thereby be provided with a cleaning element carrier which, for example, is suitable for receiving conventionally produced bristle filaments and/or bristle bundles. For example, a cleaning element, such as a bristle bundle, can be fastened with the aid of an anchor in the receiving hole produced in the cleaning element carrier by additive material application.

In a further embodiment of the toothbrush head, it is provided that the toothbrush head, in particular at the cleaning element carrier, has a fastening interface for the fastening to a toothbrush handle. It is thereby possible to provide the toothbrush head as a separate part and to fix same, preferably releasably, to a held-ready toothbrush handle. The toothbrush handle, which generally has the greatest portion of the overall mass of a toothbrush, can thus be used for a plurality of toothbrush head use cycles and/or can be composed, for example, of an environmentally friendly material, preferably from a biodegradable material, for example from wood. This variant of the toothbrush head thus assists an environmentally friendly and resource-protective toothbrush use.

The toothbrush head can thus be designed as a replaceable head which can be reversibly released from the toothbrush handle. The separation of the toothbrush head from the toothbrush handle after use of the toothbrush can be advantageous in order to permit reliable drying of the toothbrush handle, on the one hand, and of the toothbrush head, on the other hand. In particular if the toothbrush handle is composed of wood or a wood material, reliable drying can be helpful for avoiding moisture-induced damage to the toothbrush handle and for keeping the toothbrush in a hygienically satisfactory state.

The fastening interface can have or comprise at least one latching element of a latching connection, a fastening pin and/or else a pin receptacle. The fastening interface with its elements provided for the fastening can preferably likewise be produced additively. It is thereby possible at the fastening interface to produce geometries which cannot be readily produced, for example, by injection molding. The fastening interface here can have at least one conventionally non-demoldable undercut.

To achieve the object, a toothbrush having a toothbrush handle and a toothbrush head having one or more features as described herein directed toward such a toothbrush head is also proposed.

In one embodiment of the toothbrush, it can be provided that the toothbrush handle and the toothbrush head are releasably connectable to each other or connected to each other. In one embodiment of the toothbrush, it is provided that the toothbrush handle has a receptacle for the insertion of the toothbrush head. The toothbrush head can thereby be used as a replaceable head on the toothbrush handle. The toothbrush handle here can be used for a plurality of use cycles with different toothbrush heads before being disposed of.

In one embodiment, it is provided that the receptacle for the toothbrush head has an introducing groove and/or a latching groove for fixing the toothbrush head to the toothbrush handle. By means of the introducing groove, the toothbrush head can be introduced into its use position within the receptacle. It is possible with the aid of the latching groove to fix the toothbrush head releasably to the toothbrush handle.

In one embodiment of the toothbrush, it is provided that a plug-in connection and/or a latching connection are/is formed between the toothbrush handle and the toothbrush head. With the aid of such a plug-in connection and/or latching connection, the toothbrush head can be connected, preferably releasably, to the toothbrush handle. The plug-in connection and/or the latching connection, in particular the elements forming same on the toothbrush handle and on the toothbrush head, can preferably be produced additively, in particular 3D printed.

In a further embodiment of the toothbrush, it is provided that the toothbrush handle has a fastening pin onto which the brush head with its pin receptacle matching said fastening pin can be plugged. In particular when latching elements of a latching connection that match one another are formed both on the fastening pin of the toothbrush handle and in the matching pin receptacle of the toothbrush head, it is possible to fasten the toothbrush head securely and nevertheless releasably to the toothbrush handle.

In a preferred embodiment of the toothbrush, it is provided that the toothbrush handle is composed of a biodegradable material, in particular of wood, of a wood material and/or of a biodegradable plastic. Owing to its material, the toothbrush handle of the toothbrush can thus be disposed of in an environmentally friendly manner and/or recycled. Similarly, the toothbrush head of the toothbrush can also be composed of a biodegradable material, for example of a biodegradable plastic.

In a preferred embodiment of the toothbrush, the latter, in particular in and/or at its toothbrush handle and/or in or at its toothbrush head, has at least one, preferably electric and/or electronic, functional part. The at least one functional part can be, for example, a motor, a vibrator, a preferably wireless communication module and/or a sensor.

The toothbrush handle of the toothbrush can also be produced additively, in particular 3D printed. In particular if the toothbrush handle of the toothbrush has an in particular electric and/or electronic functional part, it can be expedient to hold the functional part ready and to build up the toothbrush handle around the held-ready functional part by additive material application. This creates a toothbrush, the toothbrush handle of which surrounds and receives the at least one functional part of the toothbrush without the toothbrush handle having a material weakening, for example an insertion opening, through which the functional part is inserted into the interior of the toothbrush handle.

In one embodiment of the toothbrush, both the toothbrush head and the toothbrush handle are produced additively, in particular 3D printed. The toothbrush head and the toothbrush handle can be connected inseparably to each other here, for example by additive material application, and/or can be composed of different materials. It is also possible to additively produce the toothbrush head and the toothbrush handle as separate parts and to subsequently connect same releasably to each other, as has already been explained previously. The toothbrush head can be used as a replaceable head and, after its use, can be replaced by another toothbrush head on the toothbrush handle.

In order to achieve the object, a method for producing a toothbrush head which is individualized for a user is also proposed, which method has one or more features described herein directed toward a method of this type. In order to achieve the object, in particular a method for producing a toothbrush head which is individualized for a user is thus proposed, wherein user-individualized production data are transmitted to a controller or control device of an additive manufacturing device. Depending on the user-individualized production data, at least one cleaning element carrier and/or at least one cleaning element of the toothbrush head is subsequently produced additively, in particular 3D printed, with the aid of the additive manufacturing device. The toothbrush head can be a toothbrush head as claimed in one of the claims directed toward such. An example of an additive manufacturing device which can be used is a 3D printer.

With the proposed method, toothbrush heads can thus be produced without a large mechanical outlay and rapidly and simply in accordance with the individual desires and/or requirements of a user.

In one embodiment of the method, it is provided that the production data are derived from anatomical data of the user with a data processing device, in particular a data processing device of the additive manufacturing device. The anatomical data of a user can thus form the basis for the production data for producing a user-individualized toothbrush head. A toothbrush head can thereby be produced in a manner made to measure in accordance with the desires and/or requirements of a user. The anatomical data of the user can be, for example, dental anatomy data of the user. Anatomical data of this type can be obtained, for example, by means of a dental impression of the user. If the user-individualized production data are derived from dental anatomy data of the user, it is possible to provide a made-to-measure toothbrush head which takes into consideration anatomical characteristics of a user and, for example, promotes optimized cleaning of the user's teeth taking into consideration the anatomical characteristics of the user.

In one embodiment of the method, anatomical data, in particular dental anatomy data, of a user are acquired with a data acquisition device, for example with a scanner. The data acquisition device can be, for example, part of the additive manufacturing device and/or connected thereto. The data acquisition device can, for example, acquire, in particular measure, a dental impression of a user in order to obtain the dental anatomy data of the user. From the acquired dental anatomy data, then, by means of the already previously mentioned data processing device, a set of user-individualized production data can be derived and can then be used to manufacture a user-individualized toothbrush head.

It can be provided here to adapt a geometry and/or an arrangement of cleaning elements and/or a geometry of the cleaning element carrier to the anatomy, in particular to the dental anatomy of a user.

In one embodiment of the method, it is provided that production data from a database are used as user-individualized production data. The user who would like an individualized toothbrush head and/or an individualized toothbrush can thus select, for example, from a multitude of forms of toothbrush heads and toothbrushes, the model of a toothbrush head or of a toothbrush that most meets the user's requirements. The production data regarding the selected model that are stored in the database can then be used as user-individualized production data for producing a toothbrush head and/or a toothbrush.

In one embodiment of the method, it is provided that anatomical data, in particular dental anatomy data, which match a dental anatomy of a user, are selected from a database in order, from said data, to derive user-individualized production data, in particular with a or the data processing device, and subsequently to additively produce at least one cleaning element carrier and/or at least one cleaning element of the toothbrush head depending on the user-individualized production data with the aid of the additive manufacturing device.

In a further embodiment of the method, it is provided that production data which match a dental anatomy of the user are selected as user-individualized production data from a database and are transmitted to a or the data processing device and/or to a or the control device of the additive manufacturing device in order to additively produce at least one cleaning element carrier and/or at least one cleaning element of the toothbrush head depending on the user-individualized production data with the aid of the manufacturing device.

In one embodiment of the method, a cleaning element carrier of the toothbrush head is molded additively onto at least one held-ready cleaning element, in particular molded thereon by 3D printing. For example, conventional cleaning elements, such as, for example, bristle bundles composed of bristle filaments, can thereby be connected to a cleaning element carrier which is molded additively onto the held-ready cleaning elements and in the process can be individualized. The cleaning element carrier can be provided here for example with a fastening interface, as has already been explained previously and with which the cleaning element carrier can be fastened to a toothbrush handle of a toothbrush.

In one embodiment of the method, the at least one cleaning element can be additively molded onto a held-ready cleaning element carrier. This can take place in particular by means of 3D printing. It is thereby possible to provide a cleaning element carrier, produced, for example, by injection molding, with at least one cleaning element molded additively thereon, for example with a bristle filament or with a bristle bundle composed of a plurality of bristle filaments.

In order to achieve the object, a method for producing a toothbrush is also proposed, the method having one or more features described herein directed toward a method of this type. In order to achieve the object, in particular a method for producing a toothbrush is therefore proposed, in which at least a toothbrush handle of the toothbrush is produced additively, in particular 3D printed, with the aid of an additive manufacturing device, in particular depending on user-individualized production data. The method thus permits a comparatively simple user individualization of a toothbrush handle of a toothbrush.

In one embodiment of the method, it is provided that a toothbrush head of the toothbrush is produced according to the method for producing such a toothbrush head, as is claimed in one of the claims directed toward such a toothbrush head. The toothbrush handle can be molded here onto the toothbrush head or the toothbrush head can be molded onto the toothbrush handle. It is thus possible to provide a toothbrush which has an additively manufactured toothbrush head and an additively manufactured toothbrush handle. The toothbrush head and the toothbrush handle can be individually adapted here, for example, to an anatomy, in particular to a dental anatomy of the user of the toothbrush. Also in respect of the design of the toothbrush, the method proposed in this variant permits a greatest possible freedom of design in the production of the toothbrush handle and the toothbrush head of the toothbrush.

The toothbrush handle and the toothbrush head can be produced from different materials, also and in particular whenever they are in each case produced additively, in particular 3D printed.

Thus, both the toothbrush handle and the toothbrush head can therefore be produced additively. The toothbrush handle and the toothbrush head can be produced separately, in particular 3D printed, and can then be connected releasably to each other. A toothbrush is thus created which is produced overall additively, in particular 3D printed, but the toothbrush handle and toothbrush head of which can be released from each other without being destroyed and/or reversibly. In this way, the additively produced toothbrush head can be in the form of a replaceable head and, after its use, can be replaced by a new toothbrush head on the toothbrush handle.

The toothbrush head during its additive production can also, however, be connected fixedly to the, preferably likewise additively produced, toothbrush body. The toothbrush head and the toothbrush body can be composed here of different materials, but can be connected to each other such that they cannot be separated without being destroyed.

In one embodiment of the method, it is provided that at least one, preferably electric and/or electronic, functional part of the toothbrush is connected to the toothbrush handle and/or to the toothbrush head of the toothbrush by means of additive material application. The material of the toothbrush handle and/or the material of the toothbrush head can be additively applied here around the held-ready functional part of the toothbrush. The functional part can be, for example, a motor, a vibrator, a preferably wireless communication module and/or also a sensor. The sensor here can be, for example, a pressure sensor with which a contact pressure with which the user applies the toothbrush head of the toothbrush during cleaning of mouth and teeth is sensed. Via a preferably wireless communication module of the toothbrush, a signal which represents the pressure sensed by the sensor can be transmitted to a receiving device and can be output from the latter to the user of the toothbrush. For example, a signal can be output if the pressure applied by the user via the toothbrush head to the mouth portion to be cleaned, for example to a tooth and/or the gum, reaches or exceeds a limit value.

With the aid of a motor, the toothbrush head and/or at least one cleaning element of the toothbrush head of the toothbrush can be set into motion. This is also possible with the aid of a vibrator.

In order to achieve the object, an additive manufacturing device is finally also proposed which has one or more of the features described herein directed toward such a manufacturing device. In order to achieve the object, an additive manufacturing device is thus proposed which is designed for producing a toothbrush head and/or a toothbrush according to a method as claimed in at least one of the claims directed toward such a method.

The additive manufacturing device can have, for example, a 3D printing device. In order to produce a toothbrush and/or a toothbrush head, the 3D printing device is preferably designed for processing plastic.

The additive manufacturing device can have a data acquisition device, for example with a scanner, for detecting anatomical data, in particular dental anatomy data, of a user, and/or can be at least indirectly connected to such a device. Furthermore, the additive manufacturing device can have a data processing device or can be connected to such a device, which is designed for deriving user-individualized production data from anatomical data, in particular from dental anatomy data of a user. It is thereby possible to provide the additive manufacturing device with anatomical data of a user. The provided anatomical data can then be converted by the data processing device into user-individualized production data and can be used for the user-individualized production of a toothbrush head, a toothbrush handle and/or a toothbrush.

Furthermore, the additive manufacturing device can have a controller or control device or can be connected to such a device which is designed to convert user-individualized production data into control signals for the user-individualized production of a toothbrush head and/or a toothbrush handle and/or a toothbrush. The previously mentioned 3D printing device can be activated with the control device in order to produce user-individualized toothbrush heads, toothbrush handles and/or complete toothbrushes.

It should be mentioned at this juncture that user-individualized production data can also be or comprise production data that represent a design, desired by a user, of the toothbrush, in particular the toothbrush handle, the toothbrush head, the cleaning element carrier and/or the at least one cleaning element. Production parameters here can be inter alia the color, the shape, the material, the composition and/or the dimensions of the previously mentioned elements.

In order to achieve the object, finally a computer program is also proposed which has one or more of the features described herein directed toward a computer program. According thereto, the computer program has commands which cause the additive manufacturing device as claimed in one of the claims directed toward such a device to execute the method steps as claimed in at least one of the method claims directed toward a method for producing a toothbrush head and/or toward a method for producing a toothbrush. The computer program can be stored here on a computer-readable medium. A database can also serve as a computer-readable medium.

### BRIEF DESCRIPTION FO THE DRAWINGS

The invention will now be described in more detail with reference to exemplary embodiments. The invention is not restricted to the exemplary embodiments shown. Further exemplary embodiments of the invention emerge from a combination of the features of individual claims or a plurality of claims with one another and/or in a combination of individual features or a plurality of features of the exemplary embodiments shown.

In a partially highly schematized illustration:

FIG. 1 shows a perspective illustration of a first embodiment of a toothbrush, comprising a toothbrush head and a toothbrush handle, wherein the toothbrush handle has a fastening pin and the toothbrush head has a pin receptacle matching said fastening pin, with which the toothbrush head and the toothbrush handle can be connected releasably to each other,

FIG. 2 shows the toothbrush from FIG. 1 with the toothbrush head pushed onto the fastening pin of the toothbrush handle,

FIG. 3 shows the toothbrush from FIGS. 1 and 2 with the toothbrush head located in the fastening position on the toothbrush handle,

FIG. 4 shows a partially sectioned side view of the toothbrush from FIGS. 1 to 3,

FIG. 5 shows the detail marked by the circle in FIG. 4, in an enlarged illustration,

FIG. 6 shows a perspective illustration of an individual part of the toothbrush head of the toothbrush depicted in the previous figures,

FIG. 7 shows a perspective illustration of a toothbrush head and a toothbrush handle of a toothbrush according to a further embodiment, wherein the toothbrush handle has a receptacle for introducing the toothbrush head,

FIG. 8 shows a perspective illustration of the toothbrush from FIG. 7 with the toothbrush head partially introduced into the receptacle of the toothbrush handle,

FIG. 9 shows a perspective illustration of the toothbrush from FIGS. 7 and 8 with the toothbrush head positioned in the receptacle of the toothbrush handle,

FIG. 10 shows the detail marked by the circle in FIG. 7, in an enlarged illustration, and

FIG. 11 shows a sequence of pictograms for illustrating a method for producing a toothbrush head and/or a toothbrush, as at least partially shown in FIGS. 1 to 10.

### DETAILED DESCRIPTION

In the description below of various embodiments of the invention, elements which correspond in their function obtain corresponding reference numbers even if they differ in design or shaping.

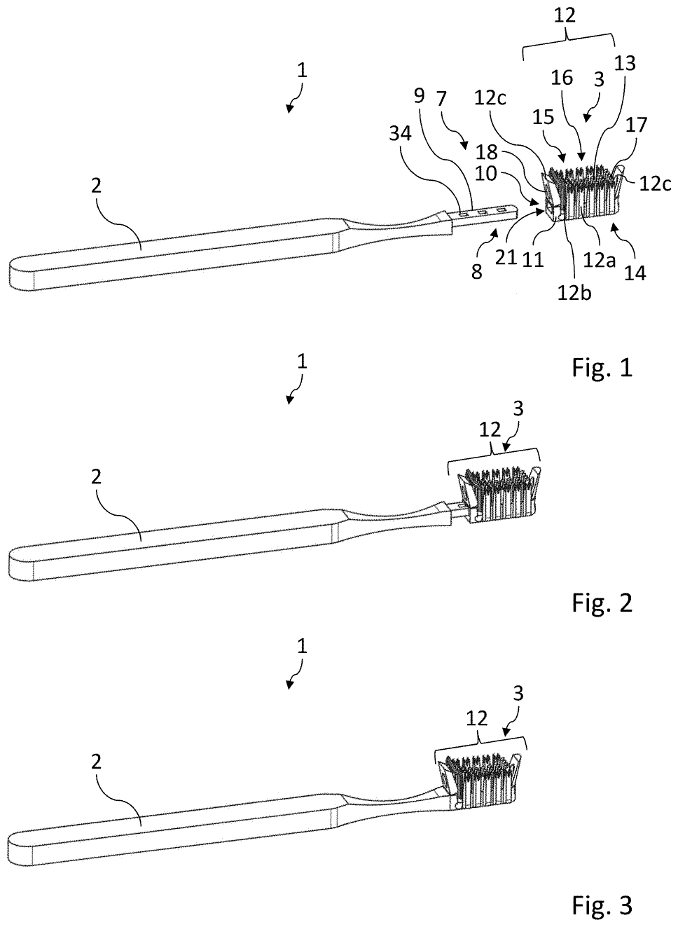

FIGS. 1 to 10 show at least parts of toothbrushes that are denoted in their entirety by 1. The toothbrushes 1 which are shown each have a toothbrush handle 2 and a toothbrush head 3 which is connectable or connected to the toothbrush handle 2.

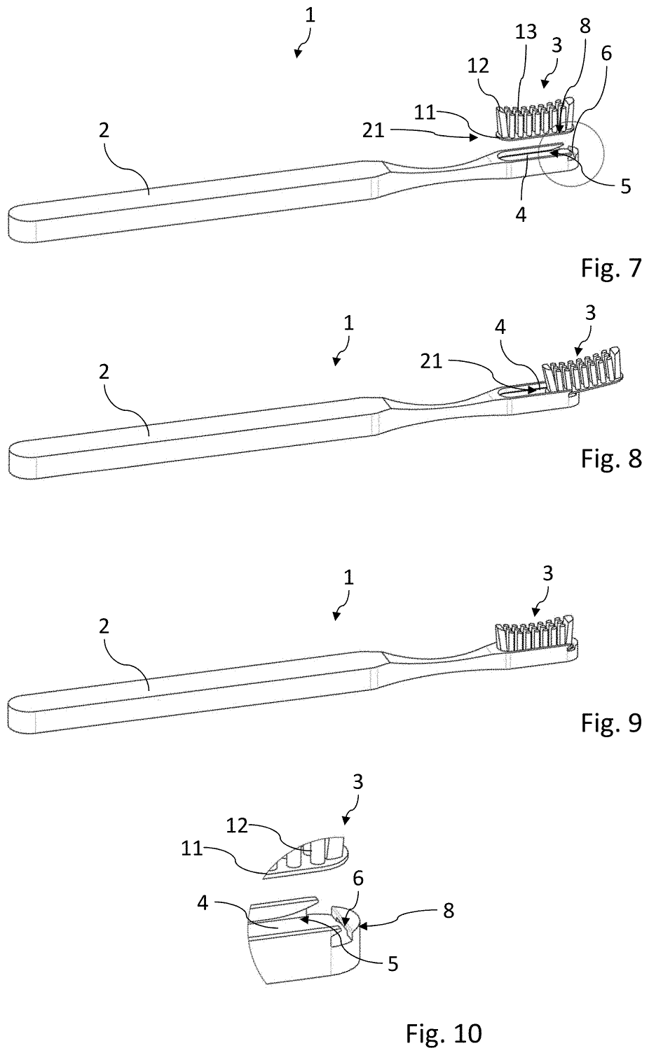

FIGS. 1 to 6 show a first embodiment of a toothbrush 1 with its toothbrush handle 2 and its toothbrush head 3. FIGS. 7 to 10 show a second embodiment of a toothbrush 1 which likewise has a toothbrush handle 2 and a toothbrush head 3.

In both embodiments of the toothbrush 1, the toothbrush handle 2 and the toothbrush head 3 are connected releasably to each other. In the exemplary embodiment shown in FIGS. 7 to 10, the toothbrush handle 2 has a receptacle 4 for the insertion of the brush head 3. The receptacle 4 comprises an introducing groove 5 and a latching groove 6 serving for fixing the toothbrush head 3 in the receptacle 4 of the toothbrush handle 2.

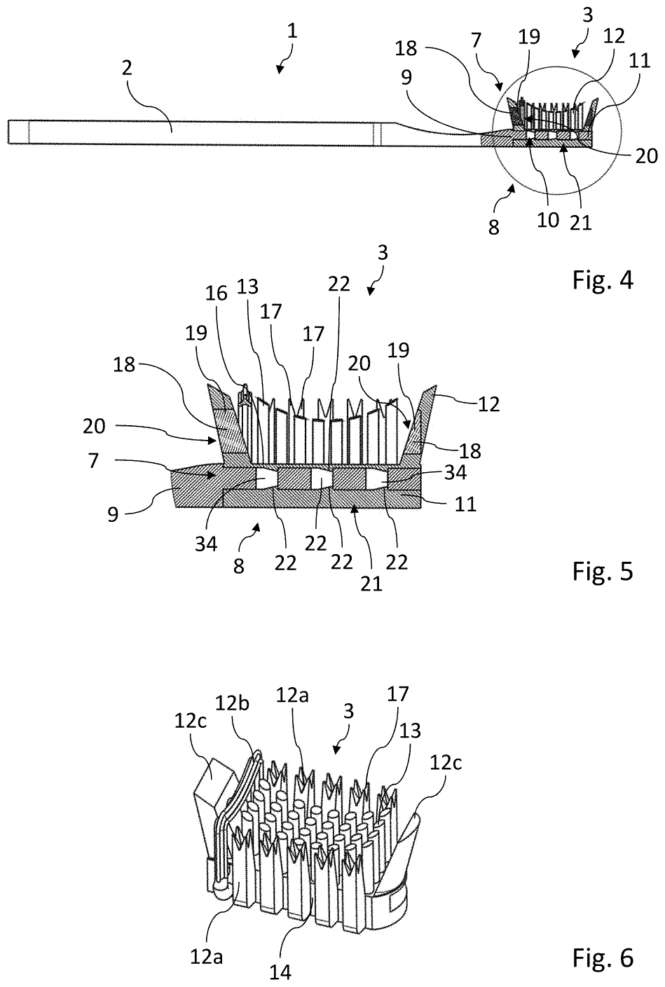

In the case of the toothbrush 1 which is illustrated in FIGS. 1 to 6, a plug-in connection 7 and a latching connection 8 are formed between the toothbrush handle 2 and the toothbrush head 3 and can be used to connect the toothbrush head 3 securely to the toothbrush handle 2 of said toothbrush 1. The toothbrush handle 2 of the toothbrush 1, which is illustrated at least in parts in FIGS. 1 to 6, has a fastening pin 9 onto which the toothbrush head 3 with its pin receptacle 10 matching said fastening pin can be plugged. The position of the fastening pin 9 in the pin receptacle 10 of the toothbrush head 3 can be seen particularly readily in the sectional illustrations according to FIGS. 4 and 5.

FIGS. 4 and 5 also show the latching connection 8 which is formed between the toothbrush handle 2 and the toothbrush head 3, in more precise terms between the fastening pin 9 of the toothbrush handle 2 and the pin receptacle 10 of the toothbrush head 3.

In all of the toothbrushes 1 which are shown in the figures, the toothbrush handles 2 are produced from a biodegradable material. In the case of the toothbrushes 1 which are shown, the biodegradable material is a biodegradable plastic. Of course, the use of other biodegradable materials, for example wood or else wood materials, is possible.

In an embodiment of the toothbrush 1 that is not shown in the figures, the toothbrush has at least one functional part in its toothbrush handle 2 and/or in its toothbrush head 3. The functional part used can be, for example, a motor, a vibrator, a preferably wireless communication module and/or a sensor. The possible benefit of a preferably electric/electronic functional part has already been explained further above in the general part of the description.

In the case of the two toothbrushes 1 which are shown in the figures, toothbrush handles 2 are each produced additively, in particular 3D printed.

As already mentioned previously, the two toothbrushes 1 each have a toothbrush head 3. Each toothbrush head 3 which is shown comprises a cleaning element carrier 11 and a plurality of cleaning elements 12 arranged on the cleaning element carrier 11. In the case of the toothbrush heads 3 which are shown in the figures, both the cleaning element carrier 11 and the cleaning elements 12 are produced additively, in particular 3D printed.

The two toothbrush heads 3 have a plurality of different cleaning elements 12, 12a, 12b, 12c. Some of the cleaning elements 12 are composed of additively produced, in particular 3D printed bristle filaments 13. The toothbrush head 3 illustrated in FIGS. 1 to 6 moreover comprises a plurality of cleaning elements 12a which are attached laterally to the cleaning element carrier 11, namely are molded additively thereon, in particular 3D printed thereon.

According to FIG. 6, the toothbrush head 3 furthermore has an additively produced, preferably 3D printed, arcuate cleaning element 12b which connects two different, namely mutually averted side surfaces 14 and 15 of the cleaning element carrier 11, to each other and, in the process, spans a front side 16 of the cleaning element carrier 11. The side surfaces of the cleaning element carrier 11 are the surfaces which are oriented transversely with respect to the front side 16 of the cleaning element carrier 11.

The cleaning elements 12a attached laterally to the cleaning element carrier 11 can be used for cleaning mouth portions that are located laterally adjacent to the toothbrush head 3 when the toothbrush 1 is used, when the free ends of other cleaning elements 12 are brought into contact with teeth and gum of a user 27.

According to FIG. 6, the toothbrush head 3 of the toothbrush 1 illustrated in FIGS. 1 to 6 has, on each of the previously mentioned side surfaces 14 and 15, a row of additively produced, in particular 3D printed, lateral cleaning elements 12a which each have four protruding cleaning segments 17 at their free ends. Each of the cleaning segments 17 has a smaller cross section than the cleaning element 12a carrying them in the portion adjacent to the cleaning segments 17. The cleaning segments 17 are thus suitable because of their comparatively slender form for interdental cleaning, for example.

The sectional illustration of the toothbrush head 3 according to FIG. 5 shows that the two outer cleaning elements 12c at a distal and a proximal end of the toothbrush head 3 each have a cavity 18 for receiving a substance, here a cleaning agent 19, and an outlet opening 20 from the cavity 18 for dispensing the substance. The cleaning elements 12, 12a, 12b, 12c shown in the figures are built up on the respective cleaning element carrier 11 by additive material application. In an embodiment of a toothbrush head that is not illustrated in the figures, it is provided that the cleaning element carrier of said toothbrush head has at least one receiving hole for a cleaning element, which receiving hole is produced by additive material application, in particular by 3D printing.

The two toothbrush heads 3 each have at their cleaning element carriers 11 a fastening interface 21 for the releasable fastening of the toothbrush head 3 to a toothbrush handle 2.

The fastening interface 21 of the toothbrush head 3 illustrated in FIGS. 1 to 6 comprises a plurality of latching elements 22 which, when the toothbrush head 3 is fastened to the toothbrush handle 2, are part of the latching connection 8 already mentioned previously. The latching elements 22 are designed as latching projections within the pin receptacle 10 of the cleaning element carrier 11. The latching projections engage in latching openings 34 which are formed on the fastening pin 9 of the toothbrush handle 2 when the toothbrush head 3 according to FIGS. 3, 4 and 5 is plugged onto the fastening pin 9 of the toothbrush handle 2.

The toothbrush heads 3 illustrated in FIGS. 1 to 6 and 7 to 10 can be produced in a user-individualized manner in accordance with the method described below.

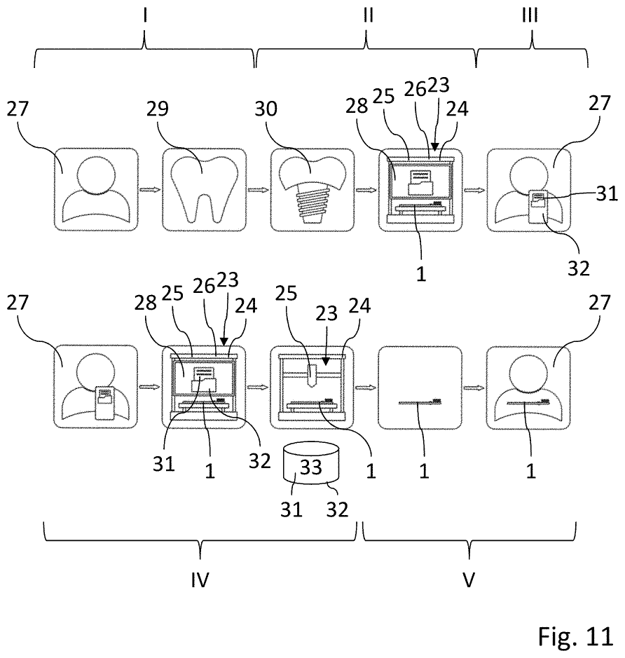

According thereto, it is provided that user-individualized production data are transmitted to a controller or control device 23 of an additive manufacturing device 24. The additive manufacturing device 24 comprises a 3D printing device 25 and is illustrated in highly schematized form in FIG. 11 in the pictogram rows of FIG. 11. Depending on the user-individualized production data, a cleaning element carrier 11 and at least one cleaning element 12, 12a, 12b, 12c of the toothbrush head 3 are then produced additively with the aid of the additive manufacturing device 24.

The production data are derived from anatomical data of the user 27 with a data processing device 26 which is part of the additive manufacturing device 24 or is at least temporarily assigned thereto. The anatomical data of the user 27 can be dental anatomy data of the user 27.

The anatomical data of the user 27 are acquired with a data acquisition device 28. For this purpose, the data acquisition device 28 can have, for example, a scanner with which a dental impression of the user 27 can be acquired, in particular measured, in order to obtain the dental anatomy data of the user 27 for further data processing. The data acquisition device 28 can be temporarily assigned at least temporarily to the additive manufacturing device 24 or can be at least temporarily part of the additive manufacturing device 24.

In principle, it is also possible to keep data sets ready for selection, for example dental anatomy data sets in a database 33. The additive manufacturing device 24, in particular via its control device 23, can at least temporarily access said database 33 in order to obtain and/or to read the data sets. It is thus possible to use an as far as possible matching, dental anatomy data set for the user-individualized production of the toothbrush head 3 without undertaking an individual acquisition of the dental anatomy of the user 27.

The database 33 can furthermore contain data sets with production data which can be used as user-individualized production data. The production data can represent different models of toothbrush heads and/or toothbrushes. From the production data contained in the database 33, the user 27 can select the matching production data in order to produce a toothbrush handle 2, a toothbrush head 3 or an entire toothbrush 1 in accordance with the user's individual ideas.

The user-individualized production makes it possible to adapt a geometry and/or an arrangement of cleaning elements 12, 12a, 12b, 12c and/or a geometry of the cleaning element carrier 11 to an anatomy, in particular to a dental anatomy, of the user 27. This permits optimized use of the toothbrush 1 provided with the toothbrush head 3.

In one embodiment of the method, it is provided to mold the cleaning element carrier 11 of the toothbrush head 3 onto a held-ready cleaning element 12. This can preferably take place by means of 3D printing.

In one embodiment of the method, it is provided to additively mold at least one cleaning element 12 onto a held-ready cleaning element carrier 11. This can also take place, for example, by means of 3D printing.

In order to produce an entire toothbrush 1, it is provided in terms of the method that at least the toothbrush handle 2 of the toothbrush 1 is produced additively, in particular 3D printed, with the aid of the additive manufacturing device 24 already mentioned previously, preferably depending on user-individualized production data.

In order also to permit full user individualization of the toothbrush 1, it is expedient to produce the toothbrush head 3 of the toothbrush 1 in a user-individualized manner according to the method already explained previously. The toothbrush handle 2 can be molded here onto the toothbrush head 3. It is also possible to mold the toothbrush head 3 during its additive manufacturing onto the toothbrush handle 2.

When required, it is also possible to connect at least one, preferably electric and/or electronic, functional part to the toothbrush handle 2 and/or to the toothbrush head 3 by means of additive material application. In this case, a preferably electric and/or electronic functional part can be held ready and then surrounded with material during the additive production of the toothbrush handle 2 and/or during the additive production of the toothbrush head 3 and housed by the toothbrush handle 2 and/or by the toothbrush head 3. The electric and/or electronic functional part can be, for example, a motor, a vibrator, a preferably wireless communication module and/or a sensor.

The previously explained methods can be carried out on the additive manufacturing device 24 already mentioned previously. The additive manufacturing device 24 is designed here both for producing the toothbrush heads 3, already explained in detail previously, and for producing the entire toothbrush 1 which then comprises the toothbrush head 3 and a toothbrush handle 2.

The already previously mentioned data acquisition device 28, the already previously mentioned data processing device 26 and also the already previously mentioned control device 23 can be at least temporarily assigned to the additive manufacturing device 24. The control device 23 is designed to convert user-individualized production data into control signals for the user-individualized production of the toothbrush head 3 or the toothbrush handle 2 and/or even the entire toothbrush 1.

With reference to the sequence of pictograms from FIG. 11, an application of the method explained previously can be described as follows:

a user 27 goes to a dentist 29 to have an impression of the user's teeth made (step I). The impression of the teeth is acquired and measured by a dental laboratory 30 with a data acquisition device 28 (step II). User-individualized production data are produced here and are made available to the user for further use (step III). The user-individualized production data and/or the anatomical data, in particular the dental anatomy data, can be stored on a computer-readable medium 32, for example in a data memory, and the computer-readable medium 32 can be passed to the user 27. The user 27 can use the user-individualized production data passed to the user and/or the anatomical data to additively produce a user-individualized toothbrush 1, which then has a user-individualized toothbrush head 3 and/or a user-individualized toothbrush handle 2, with the aid of an additive manufacturing device 24 (step IV in FIG. 11). The result of this method is a toothbrush 1 which is individualized to the dental anatomy of the user 27 and can be used by said user (step V in FIG. 11).

The user-individualized production data made available to the user 27 can be made available to the user in the form of and/or as part of a computer program 31 on a computer-readable medium 32. The computer program 31 can be stored in the database 33 already mentioned previously. The computer program comprises commands which cause the additive manufacturing device 24 and in particular the 3D printing device 25 thereof to execute the required method steps for producing the toothbrush 1 or the toothbrush head 3. The commands of the computer program 31 and/or the user-individualized production data can be converted here by the control device 23 of the additive manufacturing device 24 into corresponding actuating and/or control signals, with the aid of which the additive manufacturing device 24 and in particular the 3D printing device 25 thereof with its corresponding actuators produce the toothbrush 1, the toothbrush handle 2 and/or the toothbrush head 3.

The invention is concerned with improvements in the technical field of toothbrushes. For this purpose, inter alia, a toothbrush head 3 is proposed, the cleaning element carrier 11 of which and/or at least one cleaning element 12, 12a, 12b, 12c of the toothbrush head 3 are/is produced additively.

### LIST OF REFERENCE SIGNS

1 toothbrush
2 toothbrush handle
3 toothbrush head
4 receptacle for 3
5 introducing groove
6 latching groove
7 plug-in connection
8 latching connection
9 fastening pin
10 pin receptacle
11 cleaning element carrier
12 cleaning element
12a lateral cleaning element
12b arcuate cleaning element
12c cleaning element with cavity
13 bristle filament
14 side surface of 11
15 side surface of 11
16 front side of 11
17 cleaning segments
18 cavity
19 cleaning agent
20 outlet opening
21 fastening interface
22 latching element
23 control device
24 additive manufacturing device
25 3D printing device
26 data processing device
27 user
28 data acquisition device
29 dentist
30 dental laboratory
31 computer program
32 computer-readable medium
33 database
34 latching opening in 9

1. A toothbrush head (3) comprising:
a cleaning element carrier (11),
at least one cleaning element (12, 12a, 12b, 12c) arranged on the cleaning element carrier (11),
wherein at least one of the cleaning element carrier (11) or the at least one cleaning element (12, 12a, 12b, 12c) is produced by an additive manufacturing process.

2. The toothbrush head (3) as claimed in claim 1, wherein the at least one cleaning element (12, 12a, 12b, 12c) is a bristle filament (13) produced by the additive manufacturing process.

3. The toothbrush head (3) as claimed in claim 1, wherein the at least one cleaning element (12, 12a, 12b, 12c) is attached laterally to the cleaning element carrier (11) by the additive manufacturing process.

4. The toothbrush head (3) as claimed in claim 1, wherein the at least one cleaning element (12, 12a, 12b, 12c) that is produced by the additive manufacturing process at least one of connects two different side surfaces (14, 15) of the cleaning element carrier (11) to each other or spans a front side (16) of the cleaning element carrier (11).

5. The toothbrush head (3) as claimed in claim 1, wherein the at least one cleaning element (12, 12a, 12b, 12c) is produced by the additive manufacturing process and has at least two cleaning segments (17) at a free end thereof.

6. The toothbrush head (3) as claimed in claim 1, wherein the at least one cleaning element (12, 12a, 12b, 12c) is produced by the additive manufacturing process and includes a cavity (18) adapted for receiving a substance and an outlet opening (20) from the cavity (12, 12a, 12b, 12c) for dispensing the substance.

7. The toothbrush head (3) as claimed in claim 1, wherein the cleaning element carrier (11) has at least one receiving hole for the at least one cleaning element (12, 12a, 12b, 12c), and the receiving hole is produced by the additive manufacturing process.

8. The toothbrush head (3) as claimed in claim 1, wherein the toothbrush head (3), has a fastening interface (21) for fastening to a toothbrush handle (2), the fastening interface (21) comprises at least one of a latching element (22) of a latching connection (8), a fastening pin, or a pin receptacle (10).

9. A toothbrush (1) having a toothbrush handle (2) and a toothbrush head (3) as claimed in claim 7.

10. The toothbrush (1) as claimed in claim 9, wherein the toothbrush handle (2) and the toothbrush head (3) are releasably connected to each other.

11. The toothbrush (1) as claimed in claim 9, wherein the toothbrush handle (2) has a receptacle (4) for insertion of the toothbrush head (3), and the receptacle (4) has at least one of an introducing groove (5) or a latching groove (6) for fixing the toothbrush head (3) to the toothbrush handle (2).

12. The toothbrush (1) as claimed in claim 9, wherein at least one of a plug-in connection (7) or the latching connection (8) is formed between toothbrush handle (2) and toothbrush head (3) and connects the toothbrush head (3) to the toothbrush handle (2).

13. The toothbrush (1) as claimed in claim 9, wherein the toothbrush handle (2) has a fastening pin (9) and the toothbrush head (3) includes a matching pin receptacle (10), and the fastening pin is plugged in the pin receptacle.

14. The toothbrush (1) as claimed in claim 9, wherein the toothbrush handle (2) is comprised of a biodegradable material.

15. The toothbrush (1) as claimed in claim 9, further comprising at least of an electric or electronic functional part.

16. The toothbrush (1) as claimed in claim 9, wherein the at least one of the toothbrush head (3) or the toothbrush handle (2) that are produced by the additive manufacturing process are composed of different materials.

17. A method for producing a toothbrush head (3) individualized for a user, the method comprising:
transmitting user-individualized production data to a controller (23) of an additive manufacturing device (24), and
manufacturing at least one cleaning element carrier (11) or at least one cleaning element (12, 12a, 12b, 12c) of the toothbrush head (3) using an additive manufacturing process based on the user-individualized production data using the additive manufacturing device (24).

18. The method as claimed in claim 17, further comprising deriving the production data from anatomical data of a user with a data processing device (26).

19. The method as claimed in claim 18, further comprising acquiring the anatomical data of a user (27) with a data acquisition device (28) by scanning a dental impression of a user (27) in order to obtain dental anatomy data of the user (27).

20. The method as claimed in claim 17, wherein data from a database (33) are used as user-individualized production data.

21. The method as claimed in claim 17, further comprising deriving user-individualized production data from anatomical data which are stored in a database (33) and which match a dental anatomy of a user (27).

22. The method as claimed in claim 21, further comprising transmitting the user-individualized production data to at least one of a data processing device (26) or the controller (23) of the additive manufacturing device (24) in order to additively produce the at least one of the cleaning element carrier (11) or the at least one cleaning element (12, 12a, 12b, 12c) of the toothbrush head (3) depending on the user-individualized production data using the additive manufacturing device (24).

23. The method as claimed in claim 22 wherein at least one of a geometry or an arrangement of at least one of the at least one cleaning element (12, 12a, 12b, 12c) or the cleaning element carrier (11) is adapted to an anatomy of the user (27).

24. The method as claimed in claim 17, wherein the cleaning element carrier (11) of the toothbrush head (3) is molded additively onto at least one held-ready cleaning element (12, 12a, 12b, 12c).

25. The method as claimed in 17, wherein the at least one cleaning element (12, 12a, 12b, 12c) is molded additively onto a held-ready cleaning element carrier (11).

26. A method for producing a toothbrush (1), the method comprising: producing at least a toothbrush handle (2) of the toothbrush (1) by an additive manufacturing process using an additive manufacturing device (24) based on user-individualized production data.

27. The method as claimed in claim 26, further comprising:
producing a toothbrush head (3) of the toothbrush (1) by transmitting user-individualized production data to a controller (23) of an additive manufacturing device (24), and manufacturing at least one cleaning element carrier (11) or at least one cleaning element (12, 12a, 12b, 12c) of the toothbrush head (3) using an additive manufacturing process based on the user-individualized production data using the additive manufacturing device (24), and
molding the toothbrush handle (2) onto the toothbrush head (3), or
molding the toothbrush head (3) is molded onto the toothbrush handle (2),
wherein the toothbrush handle (2) and the toothbrush head (3) are produced from different materials.

28. The method as claimed in claim 27, further comprising connecting at least one of an electric or electronic functional part to at least one of the toothbrush handle (2) or to the toothbrush head (3) using additive material application.

29. An additive manufacturing device (24) configured for producing at least one of a toothbrush head (3) or a toothbrush (1) according to the method claimed in claim 27.

30. The additive manufacturing device (24) as claimed in claim 27, wherein the additive manufacturing device (24) comprises a 3D printing device (25).

31. The additive manufacturing device (24) as claimed in claim 30, wherein the additive manufacturing device (24) has a data acquisition device (28) for acquiring anatomical data of a user, or is configured to be connected at least temporarily to said data acquisition device.

32. The additive manufacturing device (24) as claimed in claim 30, wherein the additive manufacturing device (24) has a data processing device (26) for deriving user-individualized production data from anatomical data of a user, or is configured to be connected at least temporarily to said data processing device, the additive manufacturing device (24) has a controller (23) or is at least configured to be temporarily connected to said controller, said controller being designed to convert user-individualized production data into control signals for the user-individualized production of at least one of the toothbrush head (3), the toothbrush handle (2), or the toothbrush (1).

33. A computer program (31), comprising commands for carrying out the method as claimed in claim 27, the commands being fixed in a non-transitory computer readable medium.
